(19) United States
(12) Patent Application Publication
(10) Pub. No.: US 2025/0190519 A1
(43) Pub. Date: Jun. 12, 2025

(54) FAST POINTWISE MULTIPLICATION IN MATRIX-VECTOR POLYNOMIAL MODULAR MULTIPLICATION

(71) Applicants: Regents of the University of Minnesota, Minneapolis, MN (US); Clemson University Research Foundation, Clemson, SC (US)

(72) Inventors: Keshab K. Parhi, Minneapolis, MN (US); Weihang Tan, Minneapolis, MN (US); Yingjie Lao, Clemson, SC (US)

(21) Appl. No.: 18/532,443

(22) Filed: Dec. 7, 2023

(51) Int. Cl. G06F 17/16; G06F 17/14

(52) U.S. Cl. CPC G06F 17/16; G06F 17/14

(57) ABSTRACT

A dedicated multiplication circuit includes inputs providing L phases of matrix elements, where each matrix element is a polynomial of x and inputs providing L phases of k vector elements, where each vector element is a polynomial of x. Circuit components perform a multiplication of the matrix and the vector in an NTT domain, wherein the circuit components comprise at most k times (L−1) pointwise polynomial modular multiplication components that receive NTT(x^{L}) as an input.

This invention was made with government support under CCF-2243053 and CCF-2243052 awarded by the National Science Foundation. The government has certain rights in the invention.

### BACKGROUND

Cryptography is used to secure data. As computing systems advance, cryptography must become more complex in order to keep data secure.

The discussion above is merely provided for general background information and is not intended to be used as an aid in determining the scope of the claimed subject matter. The claimed subject matter is not limited to implementations that solve any or all disadvantages noted in the background.

### SUMMARY

A method of performing an NTT-domain matrix-vector polynomial multiplication includes receiving a k×k matrix of polynomials, where each matrix element of the k×k matrix is a polynomial of x and receiving a k-dimensional vector, where each vector element is a polynomial of x. Each matrix element polynomial and each vector element polynomial is decomposed into L phases. The L phases of the matrix elements and the L phases of the vector elements are utilized in a circuit to calculate the product of the matrix and the vector wherein the circuit contains at most k times (L−1) pointwise polynomial modular multiplication circuits that receive an NTT transform of x as input. The product of the matrix and the vector is then provided at the output of the circuit.

An NTT-domain matrix-vector polynomial multiplication circuit includes a parallel multiplication stage that has a first group of multiplication circuits for a first element of a matrix and a second group of multiplication circuits for a second element of the matrix. A post parallel multiplication stage has a plurality of addition circuits wherein each output of the first group of multiplication circuits is input to a respective one of the plurality of addition circuits and wherein each output of the second group of multiplication circuits is input to a respective one of the addition circuits that an output of the first group of multiplication circuits is input to.

In accordance with a further embodiment, a dedicated multiplication circuit includes inputs providing L phases of matrix elements, where each matrix element is a polynomial of x and inputs providing L phases of k vector elements, where each vector element is a polynomial of x. Circuit components perform a multiplication of the matrix and the vector in an NTT domain, wherein the circuit components comprise at most k times (L−1) pointwise polynomial modular multiplication components that receive NTT(x^{L}) as an input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1(a) is a data-flow graph for an original two-parallel fast filtering structure.

FIG. 1(b) is a data-flow graph for an NTT-based polynomial multiplication using original parallel fast filtering structure.

FIG. 1(c) is a data-flow graph for a transposed two-parallel fast filtering structure.

FIG. 1(d) is a data-flow graph for NTT-based polynomial multiplication using the transposed parallel fast filtering structure.

FIG. 2(a) is an original form structure for matrix-vector polynomial multiplication algorithm for the Kyber scheme using NTT and polyphase decomposition when k=2 using fast two-parallel structure in accordance with the prior art.

FIG. 2(b) is an original form structure for matrix-vector polynomial multiplication algorithm for the Kyber scheme using NTT and polyphase decomposition when k=2 using fast two-parallel structure in accordance with an embodiment of the present invention.

FIG. 2(c) is transposed form structure for matrix-vector polynomial multiplication algorithm for the Kyber scheme using NTT and polyphase decomposition when k=2 using fast two-parallel structure in accordance with the prior art.

FIG. 2(d) is a transposed form structure for matrix-vector polynomial multiplication algorithm for the Kyber scheme using NTT and polyphase decomposition when k=2 using fast two-parallel structure in accordance with an embodiment of the present invention.

FIG. 3 is a flow diagram of a method in accordance with one embodiment.

FIG. 4 is half of a structure used to perform matrix-vector polynomial multiplication when k=2 using fast four-parallel transposed structure and sub-structure sharing technique.

FIG. 5 is the other half of the structure of FIG. 4.

FIG. 6 is a top-level architecture diagram of a low-latency design when k=2 in accordance with one embodiment.

FIG. 7(a) is a graph showing DSP usage versus clock cycle for different security levels of the present embodiments.

FIG. 7(b) is a graph showing LUT usage versus clock cycle for different security levels of the present embodiments.

### DETAILED DESCRIPTION

As part of the post-quantum cryptography (PQC) initiative, the NIST has identified and chosen the CRYSTALS-Kyber (Kyber) scheme as one of the recommended public-key encryption (PKE) and key-encapsulation mechanism (KEM) algorithm.

Kyber is derived from the learning with errors (LWE) problem that belongs to lattice-based cryptography. However, unlike other lattice-based cryptography schemes, the computational problem utilized in Kyber is module-learning with errors (M-LWE), which requires matrix-vector and vector-vector polynomial (modular) multiplications. As the entries in the matrices and vectors are polynomials over the ring, all the polynomials are converted to their number theoretic transform (NTT)-domain representation to reduce the complexity when performing entry-entry multiplication. In addition, the latest Kyber scheme employs a special parameter setting that requires polyphase decomposition before performing the NTT-based polynomial multiplication, which results in a more complicated implementation.

In fact, the integration of polyphase decomposition, fast filtering, NTT-based polynomial multiplication, sub-structure sharing, and matrix-vector polynomial multiplication in Kyber presents notable implementation and scheduling challenges not only for the algorithm but also for the hardware design.

The embodiments below provide specialized hardware for matrix-vector polynomial multiplication and NTT-based polynomial multiplication in Kyber. The hardware leverages a substructure sharing technique for matrix-vector polynomial multiplication in the NTT-domain. In the discussion below, the embodiments are referred to as KyberMat, for Kyber matrix-vector polynomial multiplication using the NTT algorithm.

Due to the large data size in the Kyber, it becomes imperative for hardware architectures to exhibit fast data processing and efficient communication while minimizing data movement to memory. Consequently, the development of a high-throughput hardware implementation becomes crucial in order to enable the swift execution of computations and handle greater number of data sequences within a given accelerator. In addition, the KyberMat accelerator provided herein uses feed-forward architectures with only one direction from input to output and is pipelined through different stages to ensure a short critical path. As a result, the KyberMat accelerator achieves a high-speed, real-time, and high-throughput performance.

As discussed below, the present embodiments use sub-structure sharing approaches for point-wise multiplication in matrix-vector polynomial multiplication based on original-form and transpose-form fast FIR filters. This sub-structure sharing reduces the number of modular multiplications and additions. Further, the embodiments reduce the number of modular multiplications and additions required, compared to previous optimizations. Our experimental results demonstrate that the proposed KyberMat significantly enhances both execution time (measured in s) and throughput performance over existing state-of-the-art designs.

### Notation and Parameter Space

Herein, the single polynomial over the ring R_{q}=Z/(xⁿ+1) is denoted as a(x). The bold symbols represent the polynomial vector, a^{ϵR}^{_{q}}^{^{k}} and polynomial matrix A^{ϵR}^{_{q}}^{^{k×k}} whose entries are polynomials. The notations a^{T} and â denote the transpose of the matrix (or vector) and the NTT-domain representation of the variable, respectively, and the ∘ symbol represents point-wise multiplication between two polynomials.

### Kyber Scheme

The Kyber scheme is a secure KEM that is indistinguishable under chosen-ciphertext attack (IND-CCA) and consists of three algorithms: key generation (KeyGen), encapsulation (Encaps), and decapsulation (Decaps). It is primarily described as an indistinguishable under chosen-plaintext attack (IND-CPA) security public-key encryption (PKE) scheme, which can be further transformed into the IND-CCA secure KEM using the Fujisaki-Okamoto transform.

Kyber provides three different security levels, i.e., Kyber-512, Kyber-768, and Kyber-1024, to satisfy NIST security levels 1, 3, and 5, respectively. To scale the security level for the Kyber scheme, we only require to change the module dimension k in k=2, 3, and 4 with multiple fixed length-n polynomials over the ring R_{q}.

The central component of the Kyber scheme is the M-LWE sample, which requires computations over vector and matrix. Specifically, the Encaps algorithm generates two M-LWE samples u∈R_{q}^{k}. For example,

$$u = {A}^{T} r + {e}_{1} \qquad ( 1 )$$

where A∈R_{q}^{k×k} and r∈R_{q}^{k} are the random matrix and vector, respectively. e₁∈R_{q}^{k} is the noisy vector, sampled from the centered binomial distribution (CBD).

### Matrix-Vector Polynomial Multiplication in Kyber Scheme

The operations required to perform on M-LWE samplers involve polynomial-based computations on matrices and vectors (module). The core operations and bottlenecks are matrix-vector and vector-vector polynomial multiplications since they involve polynomial modular multiplication and polynomial modular addition. The Kyber scheme incorporates the NTT-domain representation into its definition to reduce the computational complexity of polynomial modular multiplication. In particular, the random matrix A is naturally sampled in the NTT-domain as Â, and the keys are also stored in the NTT domain.

To efficiently perform entry-entry multiplications in Equation (1), NTT-based polynomial multiplication is used. This operation requires an NTT computation for the random vector r, which is represented as \hat{r}=NTT(r).

In general, the process of NTT-based polynomial multiplication involves converting the polynomials to their corresponding NTT-domain representations. These representations enable point-wise multiplication to generate the NTT-domain polynomial. The resulting polynomial is then transformed back to the original algebraic domain using an inverse NTT (iNTT) computation to obtain the polynomial product.

By using the NTT-domain representation, Equation (1) can be re-represented as

$$u = iNTT ( {\hat{A}}^{T} \cdot NTT ( r ) ) + {e}_{1} \qquad ( 2 )$$

The NTT-domain matrix-vector polynomial multiplication in Equation (2) plays a critical role in the Kyber scheme due to its dominance with respect to the number of modular (integer) multiplications. Hence, optimizing these computationally intensive operations in hardware can significantly improve the performance of the Kyber scheme.

The latest version of the Kyber scheme chooses a new prime q=3329, which does not satisfy q ≡1 mod 2n when n=256. As a result, the NTT-based polynomial multiplication requires a polyphase decomposition, where the NTT computations rely on 128-point and a subsequent complex point-wise multiplication.

The embodiments described below utilize a connection between fast FIR filter and point-wise multiplication in NTT-domain. This allows the use of higher-level parallelism such as four-parallel or eight-parallel in polynomial multiplication. Further, the embodiments use sub-structure sharing to further reduce the number of multiplications for point-wise multiplication. The sub-structure sharing leads to significant reduction in the complexity of the proposed architectures.

### Relationship Between Parallel Fir Filter Structure and Polynomial Modular Multiplication Using NTT and Polyphase Decomposition

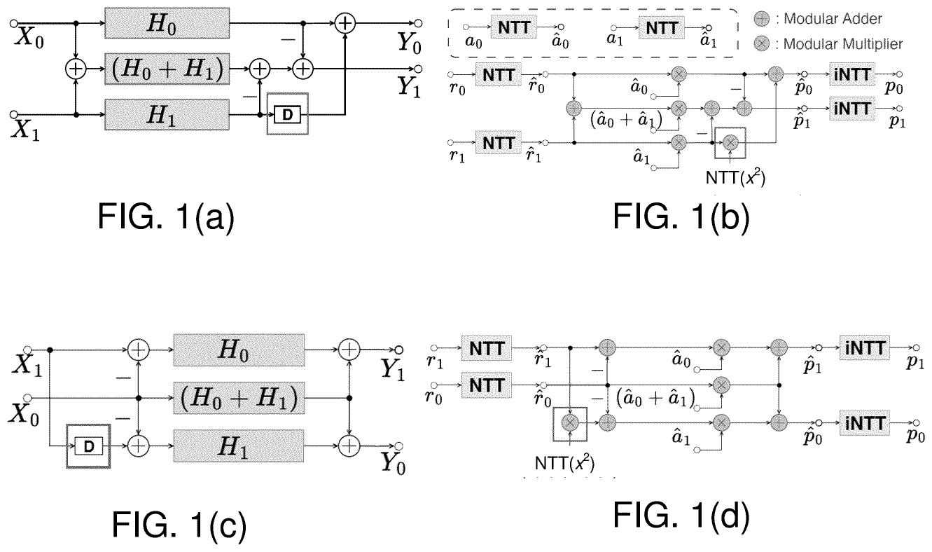

The Finite Impulse Response (FIR) filter is applied to perform the convolution on a digital signal with a finite number of taps. The fast-filtering algorithm and its structure (i.e., fast filtering structure) have been used to increase the parallelism and reduce complexity in FIR filters, ultimately improving throughput performance. Fast-filtering structures, as represented in FIG. 1(a) and FIG. 1(c), exhibit the same computational complexity. However, they differ in the data flow. FIG. 1(a) displays the original fast-filtering structure, while FIG. 1(c) demonstrates its equivalent transposed structure.

The process of computing the fast-filtering algorithm Y (z)=H(z)X(z) first involves the polyphase decomposition. The input sequence x[0],x[1],x[2], . . . is initially represented as X(z)=x[0]+x[1]z⁻¹+x[2]z⁻²+ . . . in the z-domain, which then executes the polyphase decomposition X(z)=X₀(z²)+X₁(z²)z⁻¹, where X₀(z²) and X₁(z²) are Z-transforms of the even indexed terms (x[2l]) and odd indexed-terms (x[2l+1]), respectively. The filter coefficients H(z) undergo a similar polyphase decomposition to obtain H₀(z²) and H₁(z).

The outputs of the fast-filtering algorithm are expressed as:

$${Y}_{0} ( {z}^{2} ) = {X}_{0} ( {z}^{2} ) {H}_{0} ( {z}^{2} ) + {z}^{- 2} {X}_{1} ( {z}^{2} ) {H}_{1} ( {z}^{2} ) \qquad ( 3 )$$

$$\begin{matrix}{Y}_{1} ( {z}^{2} ) = {X}_{0} ( {z}^{2} ) {H}_{1} ( {z}^{2} ) + {X}_{1} ( {z}^{2} ) {H}_{0} ( {z}^{2} ) \\ = ( {H}_{0} ( {z}^{2} ) + {H}_{1} ( {z}^{2} ) ) ( {X}_{0} ( {z}^{2} + {X}_{1} ( {z}^{2} ) ) - \\ {X}_{0} ( {z}^{2} ) {H}_{0} ( {z}^{2} ) - {X}_{1} ( {z}^{2} ) {H}_{1} ( {z}^{2} )\end{matrix} , \qquad ( 4 )$$

where Y (z)=Y₀(z²)+Y₁(z²)·z⁻¹.

Such operation involves three length −n/2 point-wise multiplications and five length-n point-wise additions/subtractions, as illustrated in FIG. 1(a) and FIG. 1(c). The delay element D plays the role of multiplication with z in a two-parallel architecture. The fast filter approach can be exploited to reduce the number of operations in the polynomial modular multiplication in the time domain. In this context, the delay element in the fast filter is equivalent to multiplication by x².

The embodiments herein use fast filter approaches to reduce the number of multiplications in the frequency domain. Here the polynomial modular multiplication is described in the frequency domain first. For a general polynomial modular multiplication p(x)=r(x)·a(x) mod (xⁿ+1), its NTT representation is defined as:

$$\begin{matrix}p ( x ) = iNTT ( NTT ( r ( x ) ) ∘ NTT ( a ( x ) ) ) \\ = iNTT ( \hat{r} ( x ) ∘ \hat{a} ( x ) )\end{matrix} \qquad ( 5 )$$

By leveraging the polyphase decomposition and fast filtering algorithm for the NTT-based polynomial multiplication, Equation (3) and Equation (4) can be expressed as

$${p}_{0} ( {x}^{2} ) = iNTT ( {\hat{r}}_{0} ( {x}^{2} ) ∘ {\hat{a}}_{0} ( {x}^{2} ) + {x}^{2} \cdot {\hat{r}}_{1} ( {x}^{2} ) ∘ {\hat{a}}_{1} ( {x}^{2} ) ) \qquad ( 6 )$$

$$\begin{matrix}{p}_{1} ( {x}^{2} ) = iNTT ( {\hat{r}}_{0} ( {x}^{2} ) ∘ {\hat{a}}_{1} ( {x}^{2} ) + {\hat{r}}_{1} ( {x}^{2} ) ∘ {\hat{a}}_{0} ( {x}^{2} ) ) \\ = iNTT ( ( {\hat{r}}_{0} ( {x}^{2} ) + {\hat{r}}_{1} ( {x}^{2} ) ) ∘ ( {\hat{a}}_{0} ( {x}^{2} ) + {\hat{a}}_{1} ( {x}^{2} ) ) - \\ {\hat{r}}_{0} ( {x}^{2} ) ∘ {\hat{a}}_{0} ( {x}^{2} ) - {\hat{r}}_{1} ( {x}^{2} ) ∘ {\hat{a}}_{1} ( {x}^{2} ) )\end{matrix} , \qquad ( 7 )$$

where \hat{r}₀(x²), \hat{r}₁(x²), â₀(x²), and â₁(x²) represent the NTT of the input polynomials after polyphase decomposition, and p(x)=p₀(x²)+p₁(x²)·x.

To apply the fast filtering algorithm to NTT-based polynomial multiplication, the embodiments transform FIG. 1(a) and FIG. 1(c), into NTT-based structures in the frequency domain, as shown in FIG. 1(b) and FIG. 1(d). However, directly utilizing the delay element in the time domain to represent multiplication by x² is not feasible in the NTT-domain. Instead, a point-wise multiplication with a pre-computed constant set, NTT(x²), of length n/2 is utilized. Higher-level parallelism can also be used.

### Algorithm-Hardware Co-Optimized Kybermat Architecture

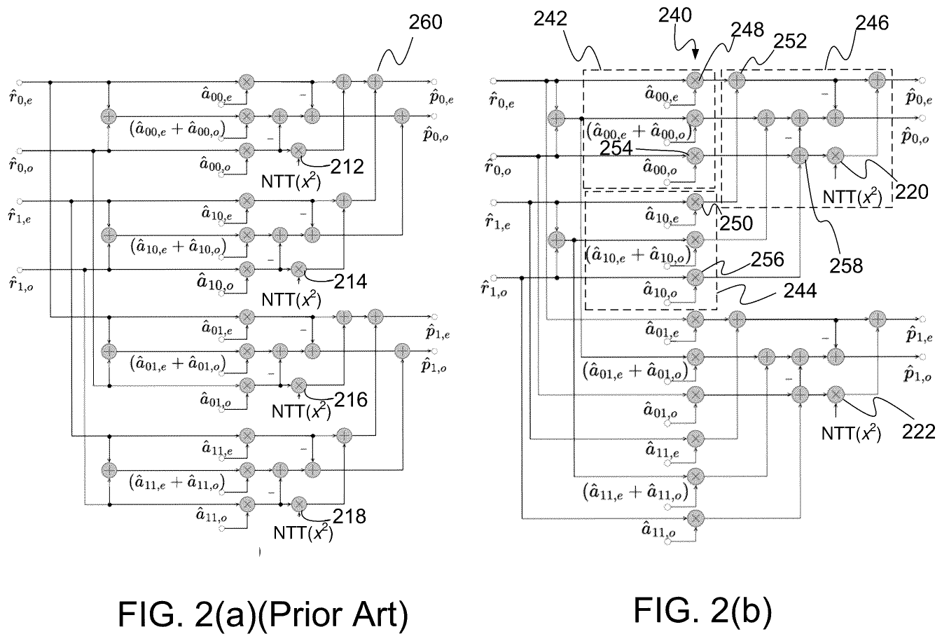

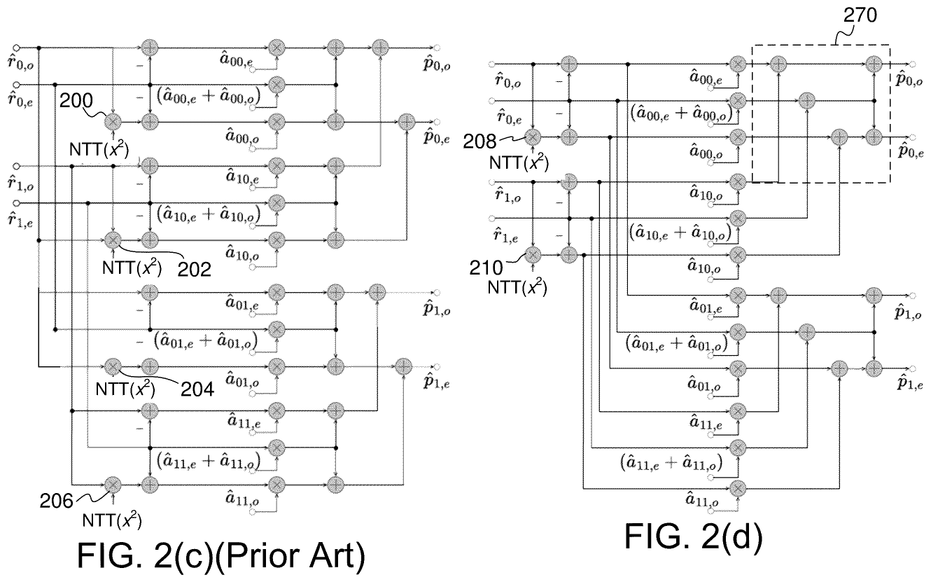

To employ the NTT algorithm and polyphase decomposition for polynomial modular multiplication for the Kyber scheme, earlier studies utilized the traditional two-parallel FIR filter implementation for the matrix-vector polynomial multiplication in NTT-domain. To minimize the number of modular multiplications in the pointwise multiplication, additional optimizations reduced the five length −n/2 point-wise multiplications down to four for each entry-entry multiplication. A data-flow graph, based on an example when k=2 from earlier work, and derived from FIG. 1(b), is shown in FIG. 2(a). Its equivalent transposed structure is depicted in FIG. 2(c). However, all of these prior optimizations still necessitate executing length −n/2 point-wise multiplication with NTT(x²) for each entry-entry multiplication, leading to k² such operations in total for a single matrix-vector polynomial multiplication.

Different from these prior works, embodiments herein use the KyberMat architecture, an efficient algorithm and hardware co-optimization for matrix-vector polynomial multiplication in the Kyber scheme. In this section, a transposed structure (FIG. 2(c)) is used as a baseline example design to demonstrate our optimization by utilizing the sub-structure sharing technique to reduce computational complexity. In further embodiments, this optimization is extended and generalized to the original structure (FIG. 1(a)). Still further embodiments utilize a low-latency architecture design for KyberMat. In accordance with most embodiments, substructure share is used to achieve hardware savings in the proposed KyberMat architecture. The substructure sharing is achieved in a natural way in the fast transpose structure and after applying distributivity and associativity in the original fast structure.

### Efficient Algorithm of KyberMat Using Transposed Two-Parallel Fast Filtering Structure

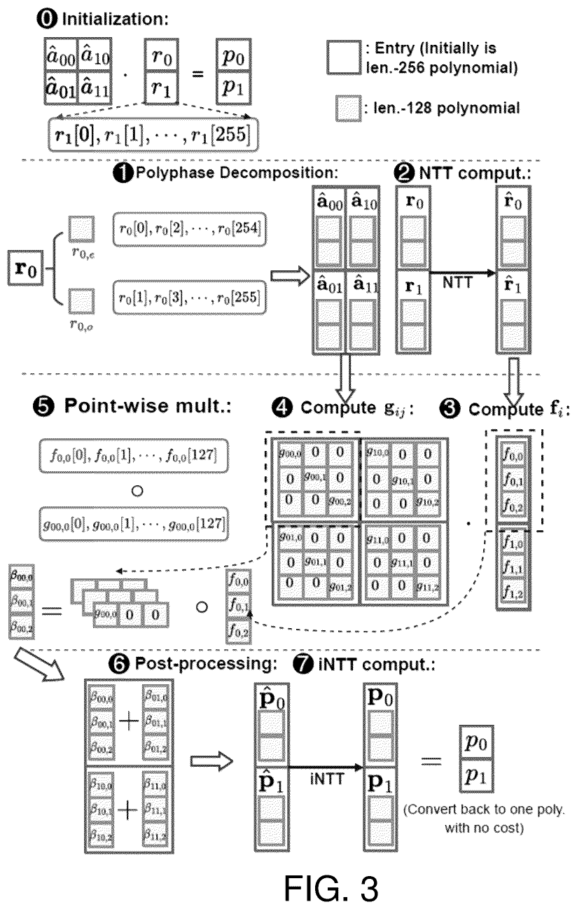

The proposed algorithm for KyberMat to compute p=A^{T}r∈R_{q}^{k} is illustrated in Algorithm 1 below, which consists of three stages: (i) preprocessing for the input matrix and vector (Lines 1-8), (ii) efficient point-wise multiplication in NTT-domain (Lines 9-11), and (iii) postprocessing (Lines 12-18). FIG. 3 shows a pictorial representation of the computations performed during Algorithm 1 when k=2.

In step 0 of FIG. 3, a k×k matrix Â of polynomials of x is received where each entry â_{i,j}, in the matrix is a polynomial representing an NTT transform of a polynomial of x in an entry a_{i,j} of a k×k matrix A. In step 1 of FIG. 3, a k-dimensional vector r is received where each of the k elements rᵢ of r is a polynomial of x. As required by Kyber, each polynomial inside the vector initially undergoes a polyphase decomposition into L phases as shown by step 1 of FIG. 3. In addition, each polynomial inside matrix Â undergoes a polyphase decomposition into L phases. Note that after polyphase decomposition, for L=2, each entry in the matrix or vector becomes a vector with two polynomials, i.e., rᵢ=[r_{i,e}(x²),r_{i,o}(x²)]^{T}, for i∈[0,k−1] and â_{i,j}=[â_{i,j,e}(x²), â_{i,j,0}(x²)], for i∈[0,k −1] and j∈[0,k −1].

### Algorithm 1 Efficient Matrix-Vector Polynomial Multiplication for Kyber

| | Input: Â^{T} and r |
|---|---|
| | Output: p= A^{T} r ∈ R_{q}^{k} |
| 1: | for i = 0 to k − 1 do |
| 2: | rᵢ(x) = r_{i,e}(x²) + r_{i,o}(x²) · x |
| 3: | \hat{r}_{i,e} = NTT(r_{i,e}(x²)); \hat{r}_{i,o} = NTT(r_{i,o}(x²)) |
| 4: | fᵢ, _{{0,1,2}} = {\hat{r}_{i,o} − \hat{r}_{i,e}, r_{i,e}, \hat{r}_{i,o} ° NTT(x²) − \hat{r}_{i,e} } |
| 5: | for i = 0 to k − 1 do |
| 6: | for j = 0 to k − 1 do |
| 7: | â_{i,j} = â_{i,j,e} + â_{i,j,o} · x |
| 8: | g_{ij,} {_{0,1,2}} = {â_{i,j,e}, â_{i,j,e} + â_{i,j,o}, â_{i,j}, o } |
| 9: | for i = 0 to k − 1 do |
| 10: | for j = 0 to k − 1 do |
| 11: | β_{ij, {0,1,2}} = g_{ji, {0,1,2}} ° f_{i, {0,1,2}} |
| 12: | for i = 0 to k − 1 do |
| 13: | for j = 0 to k − 1 do |
| 14: | sumᵢ, _{{0,1,2}} = sum_{i, {0,1,2}} + β_{ij, {0,1,2}} |
| 15: | for i = 0 to k − 1 do |
| 16: | \hat{p}_{i,e} = sum_{i,1} + sum_{i,2}; \hat{p}_{i,o}= sum_{i,1} + sum_{i,0} |
| 17: | p_{i,e}(x²) = iNTT(\hat{p}_{i,e}); p_{i,o}(x²) = iNTT(\hat{p}_{i,o}) |
| 18: | pᵢ(x) = p_{i,e}(x²) + p_{i,o}(x²) · x |

In step 2 of FIG. 3, NTT computations are performed on the two phases of r to produce \hat{r}_{i,e}=NTT(r_{i,e}(x²)) and \hat{r}_{i,o}=NTT(r_{i,o}(x²)) Since matrix Â^{T} is naturally in NTT representation after sampling, no NTT computation is required.

In step 3 of FIG. 3 and line 4 of Algorithm 1, each vector element \hat{r}ⁱ, i∈[0,k−1] is transformed into a new vector fᵢ=[f_{i,0},f_{i,1},f_{i,2}]∈R_{n/2}³ with three length-2 polynomials. In a similar fashion, each â_{ij, i∈[0,k -1],j∈[0,k -1]} is redefined as gᵢⱼ=[g_{ij,0},g_{ij,1}g_{ij,2}]∈R_{n/2}³, as illustrated in lines 5-8 in Algorithm 1 and step 4 of FIG. 3.

After the pre-processing stage, a total of 3k² point-wise multiplications are executed for the polynomials in fᵢ and gⱼᵢ, i,j,∈[0,−k]. As a result, 3k² intermediate products βᵢⱼ are produced, as illustrated in step 5 of FIG. 3 and lines 9-11 in Algorithm 1. As A is transposed before the matrix-vector polynomial multiplication in Equation (2), fᵢ is multiplied by gⱼᵢ instead of gᵢⱼ.

The post-processing stage, presented in lines 12-16 in Algorithm 1 and step 6 of FIG. 3, only requires computing the sum of βᵢⱼ in each row by additions. Subsequently, these sums are combined to form \hat{p}_{i,e}(x²) and \hat{p}_{i,o}(x²), i∈[0,k−1]. In step 7 of FIG. 3, an inverse NTT is computed for \hat{p}_{i,e}(x²) and \hat{p}_{i,o}(x²), i∈[0,k−1] to produce \hat{p}_{i,e}(x²) and p_{i,o}(x²), i∈[0,k−1].

The hardware structure used to implement Algorithm 1 for k=2 and L=2 is shown in FIG. 2(d). The hardware structure used under the prior art to perform the matrix-vector multiplication is shown in FIG. 2(c). Comparing FIGS. 2(d) and 2(c), it can be seen that the present embodiments require significantly fewer components because the present embodiments utilize sub-structuresharing.

The prior art hardware structure of FIG. 2(c) requires multiplications with NTT(x²) in each entry-entry multiplication, thereby resulting in k²(L−1) length −n/L pointwise multiplications. Thus, in FIG. 2(c) there are k²(L−1)=2²(2−1)=4 multiplication circuits 200, 202, 204 and 206 that each multiply a respective value by NTT(x²) using length −n/2 pointwise multiplications. However, this approach does not integrate steps across different levels. Further optimization could be achieved by minimizing the repetitive computations that are shared across different operational levels, such as matrix-vector multiplication and NTT-based polynomial multiplication using polyphase decomposition. The present embodiments, however, employ a sub-structure sharing technique to reduce the number of pointwise multiplications with NTT(x²) from k² (L−1) to k(L−1). Thus, in FIG. 2(d) there are only k(L−1)=2(2−1)=2 multiplication circuits 208 and 210 that multiply a respective value by NTT(x²) using length −n/2 pointwise multiplications.

The matrix-vector polynomial multiplication requires the dot-product in each row of Â^{T} to multiply with the same \hat{r}. This hardware structure can reduce the total computational cost by increasing the reuse opportunities for the intermediate results achieved from the expensive operation. Since the operation of point-wise multiplication is expensive, the hardware structure of the present embodiments arranges the multiplications with NTT(x²) and the vector \hat{r}ᵢ in the pre-processing stage by leveraging the transposition property from the transposed two-parallel fast filtering structure for the sub-structure sharing. Therefore, fᵢ, i∈[0,k−1] containing the intermediate result from the expensive operation can then be shared by the entry-entry multiplication as illustrated in FIG. 2(d).

The prior art hardware structure of FIG. 2(c) is a transpose of an original prior art hardware structure shown in FIG. 2(a). Under an alternative embodiment, the hardware structure of FIG. 2(a) is improved by using sub-structure sharing as shown in FIG. 2(b). Specifically, the distributivity property of multiplication and associativity property of add operations are exploited to utilize the sub-structure sharing technique. These optimizations allow relocation of pointwise multiplication with NTT(x²) to occur after the summation of the intermediate results β_{ij,2} rather than before. This optimization can be described by:

$$( {β}_{00 , 0} + NTT ( {x}^{2} ) {β}_{00 , 2} ) + ( {β}_{01 , 0} + NTT ( {x}^{2} ) {β}_{01 , 2} ) = ( {β}_{00 , 0} + {β}_{01 , 0} ) + NTT ( {x}^{2} ) ( {β}_{00 , 2} + {β}_{01 , 2} ) . \qquad ( 8 )$$

This reordering minimizes the total number of expensive pointwise multiplications. Specifically, in the prior art hardware structure of FIG. 2(a) there are k²(L−1)=2²(2−1)=4 multiplication circuits 212, 214, 216 and 218 that multiply a respective value by NTT(x²) using length −n/2 pointwise multiplications while in the present embodiment of FIG. 2(b) there are k(L−1)=2(2−1)=2 multiplication circuits 220 and 222 that multiply a respective value by NTT(x²) using length −n/2 pointwise multiplications.

The hardware structure presented in FIG. 2(b), and its computational complexity is the same as that of FIG. 2(d). Both structures can be used interchangeably.

Furthermore, the hardware structures of the present embodiments use fewer point-wise additions than the prior art. As shown in FIG. 2(b), a parallel multiplication stage 240 includes a group of multiplication circuits for each element of matrix Â, such as a first group of multiplication circuits 242 for a first element â₀₀ of matrix Â and a second group of multiplication circuits 244 for a second element â₁₀ of matrix Â. Post parallel multiplication stages include a plurality of addition circuits. For example, post parallel multiplication stage 246 has a plurality of addition circuits, wherein each output of the first group of multiplication circuits 242 is input to a respective one of the plurality of addition circuits and each output of the second group of multiplication circuits 244 is input to a respective one of the addition circuits that an output of the first group of multiplication circuits is input to. For instance, the output of multiplication circuit 248 of first group 242 and the output of multiplication circuit 250 of second group 244 are both input to the same addition circuit 252 while the output of multiplication circuit 254 of first group 242 and the output of multiplication circuit 256 of second group 244 are both input to the same addition circuit 258. This hardware structure reduces the number of addition circuits needed to form the final product for each element of the output vector. For example, in the prior art hardware structure of FIG. 2(a), there are eight addition circuits, such as addition circuit 260, after the parallel multiplication circuits that are used to form output vector element \hat{p}₀, which consists of phases \hat{p}_{0,e} and \hat{p}_{0,0}. However, in the embodiment of FIG. 2(b), there are only six addition circuits, such as addition circuit 252, in post parallel multiplication stage 246. Similarly, post parallel multiplication stage 270 of FIG. 2(d) has five addition circuits for forming element \hat{p}₀, whereas the prior art hardware structure of FIG. 2(c) requires six addition circuits to form element \hat{p}₀. Thus, the post parallel multiplication stages of the present embodiments require fewer circuit elements and are therefore more efficient.

### KyberMat Using Various Fast Filtering Structures and Levels of Parallelism

As presented above, matrix-vector polynomial multiplication using the NTT algorithm can be designed by exploiting various types of fast filter approaches. The transpose form of a fast filter structure is another equivalent fast filter. Higher-length parallel filters can be designed by either iterating shorter-length filters or by using iterated fast convolution algorithms followed by post-processing.

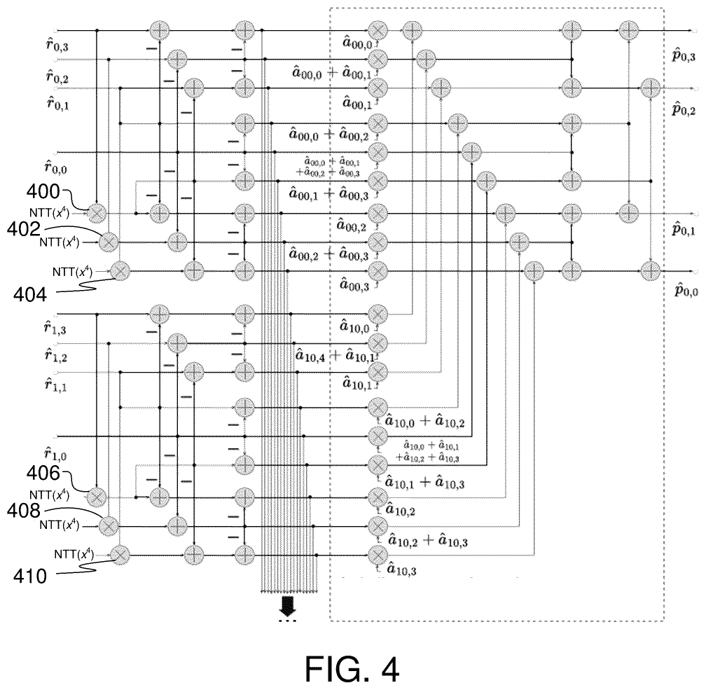

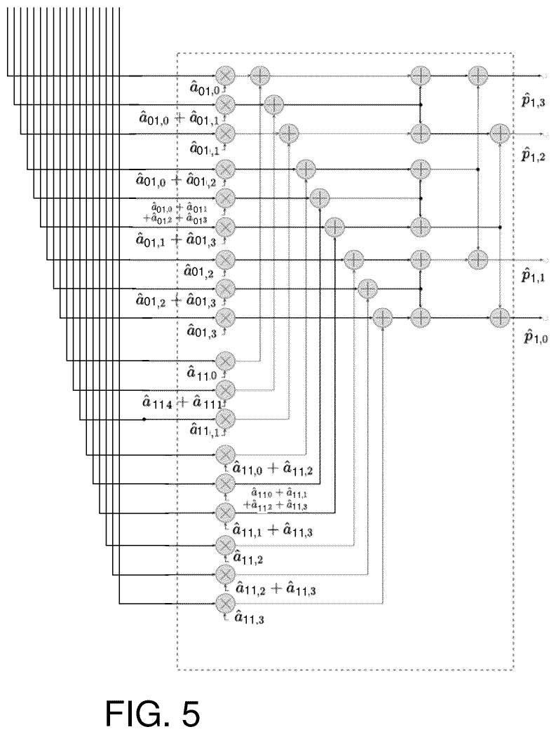

In a further embodiment, sub-structure sharing is used to produce a four-parallel structure (L=4). An example of such a structure for k=2 and L=4 is shown in FIGS. 4 and 5. The vertical lines shown extending toward the bottom of FIG. 4 connect with the vertical lines extending to the top of FIG. 5. In this embodiment, each polynomial rᵢ(x) is decomposed into four polynomials of length-64 in the polyphase decomposition step: rᵢ(x)=r_{i,0}(x⁴)+r_{i,1}(x⁴)·x+r_{i,2}(x⁴)·x²+r_{i,3}(x⁴)·x³, denoted as rᵢ=[r_{i,0}(x⁴),r_{i,1}(x⁴),r_{i,2}(x⁴),r_{i,3}(x⁴)]^{T}. Each matrix element is similarly decomposed into four phases. Consequently, the 64-point NTT/iNTT computations and length-64 point-wise multiplications can be utilized. Instead of multiplying by NTT(x²), this embodiment multiplies values by NTT(x⁴). As shown in FIGS. 4 and 5, the products resulting from multiplying NTT(x⁴) by phases of the first and second elements of vector r are determined once for \hat{p}₀(FIG. 4) and then are reused for \hat{p}₁ (FIG. 5). As a result, instead of using k²(L−1)=2²(4−1)=12 multiplication circuits for multiplying by NTT(x⁴) using length −n/4 pointwise multiplications, the embodiment uses k(L−1)=2(4−1)=6 multiplication circuits 400, 402, 404, 406, 408, and 410 for multiplying by NTT(x⁴) using length −n/4 pointwise multiplications.

In addition to the reduction of computational complexity, employing a fast four-parallel structure in the hardware implementation of the algorithm can also reduce the latency of the system as the parallelism is increased. Since each component is responsible for only n/4 modular multiplications, the latency consumption is halved compared to the fast two-parallel structure.

Significantly, utilizing a fast eight-parallel structure framework (L=8) offers further enhancements to both throughput and latency performance. The application of our sub-structure sharing technique leads to a substantial reduction in computational complexity.

### Efficient Low-Latency Implementation for KyberMat

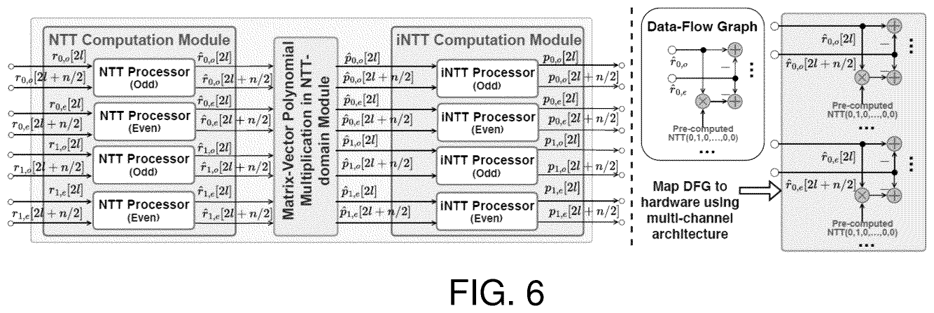

FIG. 6 provides a low latency version of the structure of FIG. 2(d). The first building block is the NTT computation module that duplicates 2k 128-point NTT processors to convert all the polynomials in r=[r₀, r₁, . . . , rₖ₋₁] to NTT-domain simultaneously, where rᵢ=[r_{i,e}(x²),r_{i,o}(x²)]^{T}. The NTT/iNTT processors are instantiated by the optimized radix-2 multi-path commutator (R2MDC)-based architecture for NTT/iNTT computation reconfigured for Kyber's parameter setting to satisfy the design criteria with real-time, multi-channels and feedforward architecture. Besides, two input data-paths are used in each R2MDC-based architecture to increase the accelerator's throughput. Each 128-point NTT processor structure consists of seven modular multipliers and fourteen modular adders/subtractors, resulting in 14k modular multipliers and 28k modular adders/subtractors for the entire NTT computation module.

The next building block is the proposed novel matrix-vector polynomial multiplication in NTT-domain module, as shown in FIG. 6. This architecture can compute all the point-wise multiplications between the polynomials in fᵢ and gⱼᵢ simultaneously. As illustrated on the right-hand-side in FIG. 6, it maps each length −n/2 point-wise multiplication and addition in FIG. 2(d) into two modular multipliers and two modular adders for upper and lower data-paths. As a result, (6k²+2k) modular multipliers and (8k²+2k) modular adders/subtractors are employed in the matrix-vector polynomial multiplication in NTT-domain module. The hardware consumption in the iNTT computation module also employs 2k 128-point iNTT processors. As a result, the architecture requires 14k modular multipliers and 56k modular adders/subtractors in total for iNTT computation.

The main advantage of the low-latency architecture design for KyberMat is the significantly reduced clock cycle consumption and increased throughput. In contrast to previous works that require a large number of clock cycles for point-wise multiplication, the low-latency design parallelizes more modular multipliers in the data-path, reducing the latency in point-wise multiplication to only a few clock cycles utilized for pipelining.

### Performance Evaluation

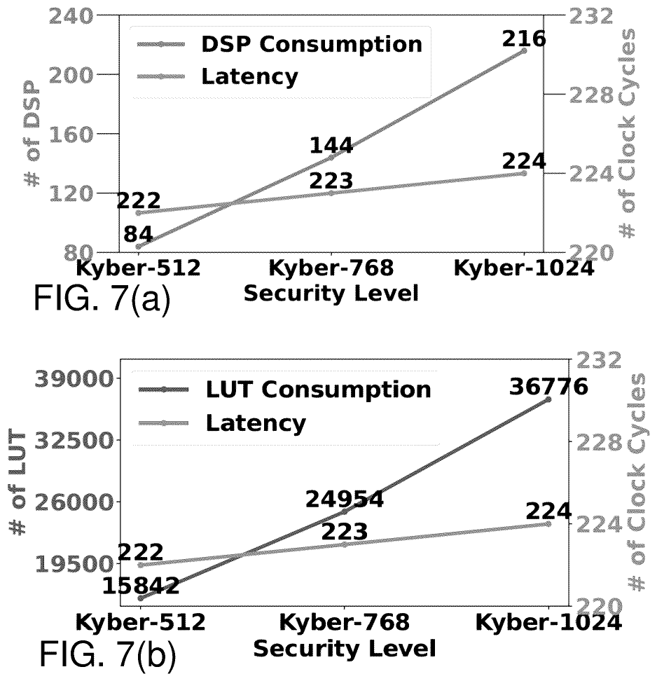

To make a fair comparison with prior works, we implement the KyberMat designs using Verilog HDL and then map them to the AC701 evaluation kit, one of the NIST-recommended Xilinx Artix-7 series FPGAs. The experimental results and comparison are presented in FIG. 7 and Table I. The prior works are selected to compare with the proposed low-latency hardware design based on the same hardware platform and Kyber's parameter (i.e., n=256, and q=3329). Two performance metrics, area and timing performances, are mainly derived in terms of LUTs (look-up tables), FFs (flip-flops), DSPs (digital signal processors), clock frequency, clock cycles, and throughput.

TABLE I
Performance of the proposed KyberMat accelerator design and prior works for Kyber-512 (k = 2, n =
256) in Artix-7 FPGA FFs (flip-flops), DSPs (digital signal processors), clock frequency, clock cycles, and throughput

| Design | LUTs (AT²P × 10⁴) | | FFs | DSPs (AT²P × 10²) | | Freq.[MHz] | Cycles (μs) | | TP[Gb/s] |
|---|---|---|---|---|---|---|---|---|---|
| Xing | 1737 | (68.37) | 1167 | 2 | (7.87) | 16. | 3200 | (19.84) | 0.31 |
| Guo | 1549 | (16.27) | 788 | 4 | (4.12) | 159 | 1614 | (10.15) | 0.61 |
| Bisheh | 720 | (121.33) | 290 | 6 | (101.11) | 115 | 4721 | (41.05) | 0.15 |
| Bisheh (Parallel) | 1474 | (148.57) | 580 | 12 | (121.12) | 115 | 3654 | (31.77) | 0.19 |
| Zhao | 25674 | (22.34) | 3137 | 64 | (5.57) | 97.2 | 287 | (2.95) | 2.00 |
| Yaman | 9508 | (54.63) | 2684 | 16 | (9.19) | 172 | 1304 | (7.58) | 0.81 |
| Ours (Two-parallel) | 15842 | (1.58) | 11110 | 84 | (0.84) | 222 | 222 | (1.00) | 21.31 |
| Ours (Four-parallel) | 33712 | (1.50) | 24302 | 180 | (0.80) | 222 | 148 | (0.67) | 42.62 |

### Theoretical Analysis and Experimental Results for KyberMat Accelerator in Kyber-512, Kyber-768, and Kyber-1024 Theoretical Analysis: The Computational Complexities

Theoretical analysis: The computational complexities of different security levels, specifically Kyber-512, Kyber-768, and Kyber-1024, are primarily determined by the dimension of the matrix or vector.

When theoretically analyzing and comparing the computational complexity for matrix-vector polynomial multiplication in NTT-domain (i.e., excluding the NTT and iNTT computation), the optimized algorithm reduces the number of modular multiplications and modular additions/subtractions. Table II presents the computational complexity analysis for the matrix-vector polynomial multiplication in NTT-domain from different approaches when using the fast two-parallel structure.

It shows that the optimized algorithm achieves an average 15.97% reduction in modular multiplications and a 30.40% reduction in modular additions, compared to the approach presented in Xing, when k={2,3,4}. Compared to the conventional method of the Kyber scheme, it utilizes 70.57% fewer modular additions, but the optimized algorithm reduces 33.56% modular multiplications. Note that modular multiplication is much more costly than modular addition. Hence, the proposed optimization algorithm significantly reduces the overall computational complexity compared to prior designs.

TABLE II
Computational complexity of matrix-vector polynomial multiplication
(excluding NTT/iNTT) using fast two-parallel structure

| | | |
|---|---|---|
| Algorithm | # ModMult (k = 2, | # ModAdd/Sub |
| | n = 256) | (k = 2, n = 256) |
| Xing | 2k²n (2048) | $\frac{7 {k}^{2} n}{2} - kn ( 3072 )$ |
| Conv. Kyber | $\frac{5 {k}^{2} n}{2} ( 2560 )$ | k²n − kn (512) |
| Proposed | $\frac{kn + 3 {k}^{2} n}{2} ( 1792 )$ | $\frac{kn + 4 {k}^{2} n}{2} ( 2304 )$ |

Table III presents the computational complexity analysis for matrix-vector polynomial multiplication in the NTT-domain using the fast four-parallel structure, with and without the sub-structure sharing technique. The results indicate that the proposed technique leads to an average reduction of 22.43% and 37.17% in the number of modular multiplications and modular additions/subtractions, respectively, for Kyber-512, Kyber-768, and Kyber-1024 security-level (k={2,3,4}).

TABLE III
Computational complexity of matrix-vector polynomial multipli-
cation (excluding NTT/iNTT) using fast four-parallel structure

| | | |
|---|---|---|
| Algorithm | # ModMult | # ModAdd/Sub |
| | (k = 2, n = 256) | (k = 2, n = 256) |
| w.o. Sub-struc. Share | $\frac{13 {k}^{2} n}{4} ( 3328 )$ | $\frac{( 38 {k}^{2} - 9 k ) n}{4} ( 8576 )$ |
| w. Sub-struc. Share | $\frac{9 {k}^{2} n + 3 kn}{4} ( 2688 )$ | (4k² + 4k)n (6144) |

FPGA results: FIG. 7 shows the FPGA implementation results for our KyberMat accelerator in Kyber-512, Kyber-768, and Kyber1024. The area consumption and clock frequency for one matrix-vector polynomial multiplication in the NTT-domain module (i.e., excluding the NTT and iNTT computation modules) are separately presented in Table IV as well. In a cryptosystem, the speed of the Encaps (encryption) and Decaps (decryption) processes plays a vital role in determining the usability of the overall application. Recognizing this critical metric, we prioritize the timing performance in the designs, distinguishing our approach from previous compact architecture designs that rely on limited hardware resources. We adopt a trade-off strategy that involves dedicating more hardware resources to achieve higher clock frequency, lower clock cycles, and higher throughput.

Latency and speed analysis: For the timing performance, the proposed design maintains nearly constant clock cycle consumption when the security level grows. Since more hardware resources are devoted, the latency in terms of the clock cycle is reduced, which can be summarized as

$${T}_{Lat} = \frac{n}{L} - 2 + {N}_{pipe} , \qquad ( 9 )$$

where L is the level of parallelism (L=2 when using the fast two-parallel structure), and Nₚᵢₚₑ represents the additional clock cycles in pipelining stages added to the data-path in order to reduce the critical path. Note that the latency is considered as the number of clock cycles elapsed between the first data in and the last data out. In the proposed implementation, each modular multiplier is pipelined by five stages (i.e., Nₚᵢₚₑ=5). After employing additional pipelining stages into the data-paths, the critical path only requires 4.4 ns among Kyber-512, Kyber-768, and Kyber-1024.

Observation and analysis: Despite utilizing higher numbers of LUTs, DSPs, and FFs in our proposed designs, the growth trend of LUTs/DSPs usage follows a linear trajectory, with the overhead in the number of LUTs or DSPs only increasing by a factor of around 1.59× upon rising to the next higher security level. This is mainly due to the advantages provided by sub-structure sharing. Notably, the proposed design still satisfies the hardware resource constraints of the recommended Artix-7 FPGA. For instance, the proposed low-latency design for the expensive Kyber-1024 only utilizes 9.08%, 4.17%, and 13.78% over the total LUTs, FFs, and DSPs resources provided by the Artix-7 FPGA, respectively, as presented in FIG. 7.

TABLE IV
Area and timing performance for matrix-vector polynomial multiplication
(excluding NTT/iNTT) module in Artix-7 FPGA

| Security-level | LUTs | FFs | DSPs | Freq.[MHz] | Npipe |
|---|---|---|---|---|---|
| Kyber-512 | 3526 | 2996 | 28 | 222 | 12 |
| Kyber-768 | 6480 | 6030 | 60 | 222 | 13 |
| Kyber-1024 | 12144 | 11158 | 104 | 222 | 14 |

Comparison with Prior Works

We then discuss the performance of the proposed matrix-vector polynomial multiplication accelerator designs based on the two-parallel and four-parallel structures, and compare them with prior works for the case when Kyber-512 security level (k=2), as presented in Table I.

Reduced execution time: Regarding the timing performance, the proposed low-latency design outperforms other designs in terms of clock cycles and clock frequency, thus reducing execution time significantly when compared to prior works. Note that the execution time is computed as the number of clock cycles divided by frequency, denoted in microseconds (μs).

The compact designs in the prior art, which are memory-based, often suffer from a communication overhead as all intermediate results must be read from and written to memory. For example, some prior art designs require 512, 256, and 576 clock cycles for NTT computation, point-wise multiplication, and iNTT computation, respectively, with a clock frequency of 161 MHz.

In contrast, our architectures are highly optimized for pipelining, minimizing the critical path. Consequently, our low-latency design using a fast two-parallel structure reduces execution time by 89.74% on average, while using a fast four-parallel structure can further reduce the average execution time by 93.16%.

High-throughput: We use the block processing time (BPT) to evaluate the performance of a real-time architecture, defined as the time to process 256 k input coefficients or output samples. Specifically, the BPT for the low-latency design utilizing a fast two-parallel structure is 64 clock cycles. The BPT is decreased to 32 clock cycles when a fast four-parallel structure is deployed.

Each sample is 12-bit, leading to the total number of input bitstream is (256·k·12) bits. As the proposed designs operate at a clock frequency of 222 MHz, the throughput in low-latency design can be calculated as

$$\frac{256 \cdot 12 \cdot k \cdot 222}{BPT \cdot {10}^{3}} Gb / s$$

when the system is in steady-state (i.e., after the first data comes out). This is equivalent to 4k samples per clock cycle and 8 samples per clock cycle for a fast two-parallel structure. The throughput of the design using a fast four-parallel structure is doubled since 16 data-paths are placed in parallel. However, since the PEs in the prior memory-based designs have to be reconfigured to execute different operations, no data from the new input sequence can be loaded in before the entire matrix-vector polynomial multiplication computation is finished, which thus results in low throughput. As illustrated in Table I, our low-latency design using the fast two-parallel structure improves throughput by 65.81 times compared to the prior designs, while the improvement enhances to 131.63 times when using the fast four-parallel structure.

Furthermore, the low-latency designs using the fast two-parallel and four-parallel structures outperform the previous works in terms of throughput per DSP (TPD) and throughput per LUT (TPL). The results demonstrate an improvement of around 94.05% and 87.34% in TPL performance, and 87.63% and 73.50% in TPD performance, respectively, for two- and four-parallel designs.

Hardware cost efficiency analysis: The proposed designs demand more LUTs, FFs, and DSPs in trading off for speed. For instance, the proposed low-latency design using the fast two-parallel structure requires around 55.28% and 78.10% more LUTs and DSPs than prior works. The LUTs and DSPs consumption overhead increases to 76.75% and 89.78%, respectively, when using the fast four-parallel structure. To make a fair comparison between the prior compact architectures and the proposed designs, the Area Timing Square Product (AT²P) is used to jointly evaluate area performance and timing performance, as speed is more important in the proposed design. The AT²P results with respect to the DSP and LUT usages presented in Table I further demonstrate the superiority of the proposed designs over the previous works.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method of performing an NTT-domain matrix-vector polynomial multiplication comprising:
receiving a k×k matrix of polynomials, where each matrix element of the k×k matrix is a polynomial of x;
receiving a k-dimensional vector, where each vector element is a polynomial of x;
decomposing each matrix element polynomial and each vector element polynomial into L phases;
utilizing the L phases of the matrix elements and the L phases of the vector elements in a circuit to calculate the product of the matrix and the vector wherein the circuit contains at most k times (L−1) pointwise polynomial modular multiplication circuits that receive an NTT transform of x^{L} as input;
providing the product of the matrix and the vector at the output of the circuit.

2. The method of claim 1 further comprising:
applying a first matrix element to a first modular multiplication circuit to produce a first output;
applying a second matrix element to a second modular multiplication circuit to produce a second output;
applying the first output and the second output as inputs to a modular addition circuit.

3. The method of claim 2 wherein applying the first matrix element to the first modular multiplication circuit and the second matrix element to the second modular multiplication circuit comprises applying the first matrix element in parallel with the second matrix element.

4. The method of claim 3 further comprising applying a sum of two matrix elements to a third multiplication circuit in parallel with the application of the first matrix element to the first modular multiplication circuit.

5. The method of claim 3 wherein the at most k times (L−1) pointwise polynomial modular multiplication circuits that receive an NTT transform of x^{L} as input are positioned before the first and second modular multiplication circuits.

6. The method of claim 3 wherein the at most k times (L−1) pointwise polynomial modular multiplication circuits that receive an NTT transform of x^{L} as input are positioned before the first and second modular multiplication circuits.

7. The method of claim 1 wherein L is four.

8. An NTT-domain matrix-vector polynomial multiplication circuit comprising:
a parallel multiplication stage comprising:
a first group of multiplication circuits for a first element of a matrix; and
a second group of multiplication circuits for a second element of the matrix; and
a post parallel multiplication stage having a plurality of addition circuits wherein each output of the first group of multiplication circuits is input to a respective one of the plurality of addition circuits and wherein each output of the second group of multiplication circuits is input to a respective one of the addition circuits that an output of the first group of multiplication circuits is input to.

9. The circuit of claim 8 wherein the first group of multiplication circuits comprises a first multiplication circuit for a first phase of the first element of the matrix and a second multiplication circuit for a second phase of the first element of the matrix.

10. The circuit of claim 9 wherein the second group of multiplication circuits comprises a third multiplication circuit for the first phase of the second element of the matrix and a fourth multiplication circuit for the second phase of the second element of the matrix.

11. The circuit of claim 9 wherein the output of the first multiplication circuit and the output of the third multiplication circuit are input to a first addition circuit and the output of the second multiplication circuit and the output of the fourth multiplication circuit are input to a second addition circuit.

12. The circuit of claim 8 wherein the circuit receives a vector having k polynomials of x, each polynomial divided into L phases, and wherein the circuit has a plurality of pointwise polynomial multiplication circuits that receive a value of NTT(x^{L}) and wherein the number of pointwise polynomial multiplication circuits in the plurality of multiplication circuits is at most k(L−1).

13. The circuit of claim 12 wherein k is equal to two and L is equal to two.

14. The circuit of claim 12 wherein k is equal to two and L is equal to four.

15. A dedicated multiplication circuit comprising:
inputs providing L phases of matrix elements, where each matrix element is a polynomial of x;
inputs providing L phases of k vector elements, where each vector element is a polynomial of x; and
circuit components that perform a multiplication of the matrix and the vector in an NTT domain, wherein the circuit components comprise at most k times (L−1) pointwise polynomial multiplication components that receive NTT(x^{L}) as an input.

16. The circuit of claim 15 wherein the circuit components further comprise multiplication components for multiplying NTT-domain representations of the phases of the matrix elements with other respective values, wherein the multiplication components for multiplying the NTT-domain representations of the phases of the matrix elements are in parallel with each other.

17. The circuit of claim 16 wherein the parallel multiplication components comprise:
a first group of multiplication circuits for a first element of the matrix; and
a second group of multiplication circuits for a second element of the matrix.

18. The circuit of claim 17 further comprising a plurality of addition circuits wherein each output of the first group of multiplication circuits is input to a respective one of the plurality of addition circuits and wherein each output of the second group of multiplication circuits is input to a respective one of the addition circuits that an output of the first group of multiplication circuits is input to.

19. The circuit of claim 15 wherein k is greater than one.

20. The circuit of claim 15 wherein L is greater than two.
